(19) United States
(12) Patent Application Publication
(10) Pub. No.: US 2008/0154976 A1
(43) Pub. Date: Jun. 26, 2008

(54) POLICY MANAGEMENT OF LOCAL DOCUMENT REPLICA LEASING IN A COLLABORATIVE ENVIRONMENT

(76) Inventor: David M. Ogle, Cary, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/614,166

(22) Filed: Dec. 21, 2006

(51) Int. Cl. G06F 17/30

(52) U.S. Cl. 707/201; 707/E17.001

(57) ABSTRACT

Embodiments of the present invention address deficiencies of the art in respect to collaborative document management and provide a method, system and computer program product for policy based management of local document replica leasing in a collaborative environment. In one embodiment of the invention, a method for policy based management of local document replica leasing in a collaborative environment can be provided. The method can include establishing a lease policy for replicas of documents in the collaborative environment, creating a replica of one of the documents, determining lease attributes for the replica from the lease policy and associating the lease attributes with the replica, and forwarding the replica to a requesting collaborative client in the collaborative environment for editing in the collaborative client for a lease term dictated by the lease attributes.

### BACKGROUND OF THE INVENTION

1. Field of the Invention

The present invention relates to the field of document management in a collaborative computing environment and more particularly to the management of local document replicas in a collaborative computing environment.

2. Description of the Related Art

The rapid development of computer networking technologies has led to advanced modes of communication and collaboration. Using the high speed data communications network as a backbone, individuals worldwide can converge in cyberspace to share ideas, documents and images in a manner not previously possible through conventional mail, telephony and video conferencing. To facilitate collaboration over the Internet, a substantial collection of technologies and protocols have been assembled to effectively deliver data, audio, and video over the single data communications medium of the computer communications network. These technologies include shared document repositories, instant messaging, chat rooms, and application sharing.

Conventional collaborative computing includes combinations of collaborative technologies in order to provide a means for members of a collaborative community to pool their strengths and experiences to achieve a common goal. For instance, a common goal can include an educational objective, the completion of a software development project or even the creation and use of a system to manage human resources. A collaborative computing community generally can be defined by (1) a particular context, i.e. the objective of the environment, (2) membership, i.e., the participants in the environment, (3) a set of roles for the members, and (4) resources and tools which can be accessed by the membership in furtherance of the objective of the environment.

Document sharing repositories historically have formed the cornerstone of collaborative applications. In a document sharing repository, documents can be edited and viewed by multiple different collaborators associated with one another in a collaborative space. To facilitate the distributed computing experience, documents can be retrieved by individual collaborators and edited and viewed as a replica in a local document repository. When the collaborator completes editing of the document replica locally, the changes reflected in the replica can be committed to the server based copy. As it will be apparent to the skilled artisan, when multiple collaborators edit the same document, albeit when one collaborator edits a replica of the document, the content of the document will fall out of synchronization.

Ordinary document management systems address the problem of document synchronization through a checkout mechanism. In the prototypical checkout mechanism, a document to be edited by a user can be “checked out” to the end user. During the period of time when the document has been checked out to the end user, no other users can commit changes to the underlying document. In this way, changes can be applied to a document in a serial fashion only.

While conventional document management systems have effectively addressed the synchronization problem through the checkout mechanism, the checkout mechanism has given rise to a different problem—that of the end user neglecting to return a checkout out document to a repository for use by other users. Tantamount to the patron failing to return a library book, great inefficiencies can result as documents become available for editing by other users only at the whim of the user having checkout out the document. One way to address the problem of delinquent users is to permit editing of a document only as it resides on the server. Advantages of server-side manipulation of a document include a higher level of security for documents in that local replicas of a document can be accessed by unauthorized viewers—for example when a mobile computer falls into the wrong hands in the course of a theft. Notwithstanding, server-side manipulation of a document can be cumbersome and slow.

### BRIEF SUMMARY OF THE INVENTION

Embodiments of the present invention address deficiencies of the art in respect to collaborative document management and provide a novel and non-obvious method, system and computer program product for policy based management of local document replica leasing in a collaborative environment. In one embodiment of the invention, a method for policy based management of local document replica leasing in a collaborative environment can be provided. The method can include establishing a lease policy for replicas of documents in the collaborative environment, creating a replica of one of the documents, determining lease attributes for the replica from the lease policy and associating the lease attributes with the replica, and forwarding the replica to a requesting collaborative client in the collaborative environment for editing in the collaborative client for a lease term dictated by the lease attributes.

In another embodiment of the invention, a method for policy based management of local document replica leasing in a collaborative environment can include requesting and receiving a replica of a document in a collaborative environment, identifying lease attributes for the replica, detecting a replica event, and, in response to detecting the replica event, applying the lease attributes to determine whether or not to permit continued use of the replica or to commit changes in the replica and to subsequently destroy the replica.

In yet another embodiment of the invention, a collaborative document management data processing system can be provided. The system can include a host computing platform supporting a document management system managing a plurality of documents, a lease policy established for the documents, a plurality of collaborative computing clients coupled to the document management system, and lease enforcement logic coupled to each of the collaborative clients. The lease enforcement logic can include program code enabled to limit use of replicas of corresponding ones of the documents according to the lease policy. Additionally, the lease policy can include attributes limiting use of a replica to a period of time defined by one of active editing of the replica, active use of a collaborative client editing the replica, and closing of the replica.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a collaborative data processing system configure for policy based management of local document replica leasing in a collaborative environment; and,

FIGS. 2A and 2B, taken together, are a flow chart illustrating a process for policy based management of local document replica leasing in a collaborative environment.

### DETAILED DESCRIPTION OF THE INVENTION

Embodiments of the present invention provide a method, system and computer program product for policy based management of local document replica leasing in a collaborative environment. In accordance with an embodiment of the present invention, a lease policy can be associated with a replica to a collaborative document. The lease policy can dictate for how long and under what circumstances a replica can remain active. Thereafter, the lease policy can be enforced during the lease period of the replica. Once the lease expires according to the lease policy, the changes in the replica can be committed to the collaborative document and the replica can be deactivated.

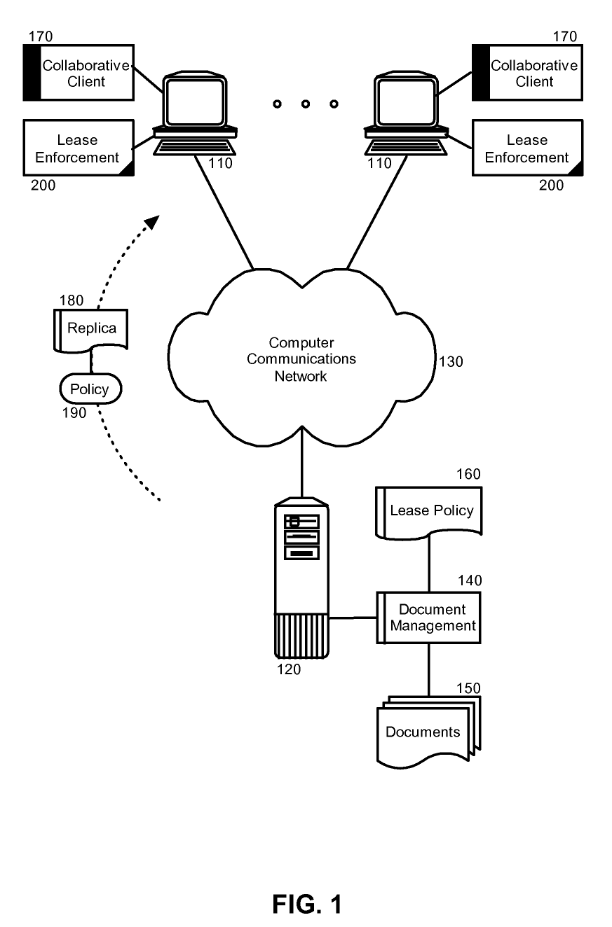

In further illustration, FIG. 1 is a schematic illustration of a collaborative data processing system configure for policy based management of local document replica leasing in a collaborative environment. The collaborative system can include a host computing platform 120 supporting the operation of a document management system 140. The document management system 140 can support collaborative access to documents 150 under management including the granting of leases to replicas for the documents 150. Communicatively coupled collaborative clients 170 hosted within corresponding client computing platforms 110 can request and receive lease grants on replicas of the documents 150. Once a lease has been granted on a document 150, a replica 180 of the document can be provided to the requesting collaborative client 170 over the computer communications network 130.

Notably, a lease policy 160 can be established in the document management system, the lease policy 160 specifying lease terms for individual replicas for associated ones of the documents 150. Correspondingly, lease enforcement logic 200 can be coupled to each of the collaborative clients 170 and can include program code enabled to enforce those lease terms for replicas loaded in the collaborative clients 170. In operation, lease terms 190 can be associated with a replica 180 according to the lease policy 160 for the document management system 140. The replica 180 and corresponding lease terms 190 can be provided to a requesting one of the collaborative clients 170. Subsequently, the lease terms 190 for the replica 180 can be enforced within the collaborative client 170. When dictated by the lease terms 190, changes to the replica 180 can be committed to a companion one of the documents 150 and the replica 180 can be deactivated or otherwise discarded.

The lease policy 160 can specify restrictions on the use of a replica in a collaborative client. For example, the lease policy 160 can specify that the lease of a replica can remain valid only so long as the replica is open for editing in the collaborative client. Upon closing the replica for editing, the changes can be committed to the corresponding document and the replica can be deleted. During the course of editing the replica, however, the lease can be continually renewed as required. As another example, the lease policy 160 can specify that the lease of a replica can remain valid only so long as the replica is open for editing and experiencing active editing. When editing activity no longer is detected in the replica, any changes can be committed to the corresponding document and the replica can be deleted. During the course of editing the replica, however, the lease can be continually renewed as required.

As a final example, the lease policy 160 can specify that the lease of a replica can remain valid only so long as the collaborative client editing the replica is active. When activity in the collaborative client is no longer detected (e.g. keyboard and mouse use), any changes can be committed to the corresponding document and the replica can be deleted. During the course of activity in the collaborative client, however, the lease can be continually renewed as required. Notably, the lease policy 160 can vary by user or replica. Additionally, authorized users can override the lease policy 160 in any particular instance for any particular replica. In any event, once the lease policy 160 has been established, lease policy attributes 190 representing the lease policy 160 as applied to the particular replica 180 can be passed to a requesting collaborative client 170 along with the requested replica 180.

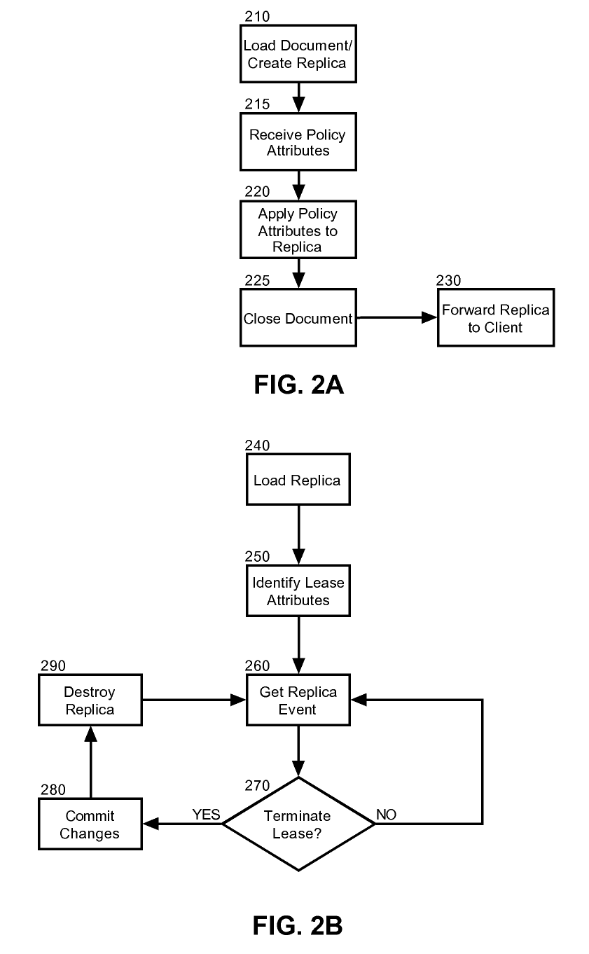

In yet further illustration, FIGS. 2A and 2B, taken together, are a flow chart illustrating a process for policy based management of local document replica leasing in a collaborative environment. The process can include a preliminary process of creating a replica and associating a particular lease policy with the replica, followed by a process of applying the lease policy to the replica in a collaborative client. Beginning first in FIG. 2A, in block 210, a document can be loaded for replication and policy attributes can be retrieved from the lease policy in block 215. In block 220, the policy attributes can be applied to the replica and in block 225, the document can be closed. Finally, in block 230 the replica can be forwarded to the collaborative client along with the policy attributes.

Turning now to FIG. 2B, in block 240, the replica can be loaded and in block 250, the lease attributes for the replica can be identified. In block 260, a replica event can be detected which can include a closing of the replica from editing, an editing timeout condition, or a computer activity timeout condition, to name only a few events. In decision block 270, it can be determined whether or not to terminate the lease based upon the lease attributes in consideration of the detected replica event. If so, in block 280, any changes to the replica can be committed to the corresponding document and in block 290, the replica can be destroyed.

In consequence of the present invention, end users can interact with a replica without suffering the slow and cumbersome nature of server-side editing of a document. Yet, synchronization problems can be avoided through programmatic lease termination. Additionally, security concerns can be addressed by limiting the presence of replicas in a local host once a lease has been terminated.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for policy based management of local document replica leasing in a collaborative environment, the method comprising:
establishing a lease policy for replicas of documents in the collaborative environment;
creating a replica of one of the documents;
determining lease attributes for the replica from the lease policy and associating the lease attributes with the replica; and,
forwarding the replica to a requesting collaborative client in the collaborative environment for editing in the collaborative client for a lease term dictated by the lease attributes.

2. The method of claim 1, wherein establishing a lease policy for replicas of documents in the collaborative environment, comprises establishing a lease policy for replicas of documents in the collaborative environment, the lease policy limiting access to a replica of a document to a period of time during which the replica is open for editing in a collaborative client.

3. The method of claim 1, wherein establishing a lease policy for replicas of documents in the collaborative environment, comprises establishing a lease policy for replicas of documents in the collaborative environment, the lease policy limiting access to a replica of a document to a period of time during which the replica is actively edited in a collaborative client.

4. The method of claim 1, wherein establishing a lease policy for replicas of documents in the collaborative environment, comprises establishing a lease policy for replicas of documents in the collaborative environment, the lease policy limiting access to a replica of a document to a period of time during which user interactive activity is detected a collaborative client.

5. The method of claim 1, wherein determining lease attributes for the replica from the lease policy, comprises overriding default lease attributes for the replica with specific lease attributes.

6. A method for policy based management of local document replica leasing in a collaborative environment, the method comprising:
requesting and receiving a replica of a document in a collaborative environment;
identifying lease attributes for the replica;
detecting a replica event; and,
responsive to detecting the replica event, applying the lease attributes to determine whether or not to permit continued use of the replica or to commit changes in the replica and to subsequently destroy the replica.

7. The method of claim 6, wherein applying the lease attributes to determine whether or not to permit continued use of the replica or to commit changes in the replica and to subsequently destroy the replica, comprises:
detecting a closing of the replica from editing; and,
responsive to detecting the closing of the replica from editing, committing changes in the replica and subsequently destroying the replica.

8. The method of claim 6, wherein applying the lease attributes to determine whether or not to permit continued use of the replica or to commit changes in the replica and to subsequently destroy the replica, comprises:
detecting a timeout condition during editing of the replica; and,
responsive to detecting the timeout condition, committing changes in the replica and subsequently destroying the replica.

9. The method of claim 6, wherein applying the lease attributes to determine whether or not to permit continued use of the replica or to commit changes in the replica and to subsequently destroy the replica, comprises:
detecting a timeout condition during use of a collaborative client editing the replica; and,
responsive to detecting the timeout condition, committing changes in the replica and subsequently destroying the replica.

10. A computer program product comprising a computer usable medium embodying computer usable program code for policy based management of local document replica leasing in a collaborative environment, the computer program product including:
computer usable program code for establishing a lease policy for replicas of documents in the collaborative environment;
computer usable program code for creating a replica of one of the documents;
computer usable program code for determining lease attributes for the replica from the lease policy and associating the lease attributes with the replica; and,
computer usable program code for forwarding the replica to a requesting collaborative client in the collaborative environment for editing in the collaborative client for a lease term dictated by the lease attributes.

11. The computer program product of claim 10, wherein the computer usable program code for establishing a lease policy for replicas of documents in the collaborative environment, comprises computer usable program code for establishing a lease policy for replicas of documents in the collaborative environment, the lease policy limiting access to a replica of a document to a period of time during which the replica is open for editing in a collaborative client.

12. The computer program product of claim 10, wherein the computer usable program code for establishing a lease policy for replicas of documents in the collaborative environment, comprises computer usable program code for establishing a lease policy for replicas of documents in the collaborative environment, the lease policy limiting access to a replica of a document to a period of time during which the replica is actively edited in a collaborative client.

13. The computer program product of claim 10, wherein the computer usable program code for establishing a lease policy for replicas of documents in the collaborative environment, comprises computer usable program code for establishing a lease policy for replicas of documents in the collaborative environment, the lease policy limiting access to a replica of a document to a period of time during which user interactive activity is detected a collaborative client.

14. The computer program product of claim 10, wherein the computer usable program code for determining lease attributes for the replica from the lease policy, comprises computer usable program code for overriding default lease attributes for the replica with specific lease attributes.

15. A computer program product comprising a computer usable medium embodying computer usable program code for policy based management of local document replica leasing in a collaborative environment, the computer program product including:
computer usable program code for requesting and receiving a replica of a document in a collaborative environment;
computer usable program code for identifying lease attributes for the replica;
computer usable program code for detecting a replica event; and,
computer usable program code for, responsive to detecting the replica event, applying the lease attributes to determine whether or not to permit continued use of the replica or to commit changes in the replica and to subsequently destroy the replica.

16. The computer program product of claim 15, wherein the computer usable program code for applying the lease attributes to determine whether or not to permit continued use of the replica or to commit changes in the replica and to subsequently destroy the replica, comprises:
computer usable program code for detecting a closing of the replica from editing; and,
computer usable program code for, responsive to detecting the closing of the replica from editing, committing changes in the replica and subsequently destroying the replica.

17. The computer program product of claim 15, wherein the computer usable program code for applying the lease attributes to determine whether or not to permit continued use of the replica or to commit changes in the replica and to subsequently destroy the replica, comprises:
computer usable program code for detecting a timeout condition during editing of the replica; and,
computer usable program code for, responsive to detecting the timeout condition, committing changes in the replica and subsequently destroying the replica.

18. The computer program product of claim 15, wherein the computer usable program code for applying the lease attributes to determine whether or not to permit continued use of the replica or to commit changes in the replica and to subsequently destroy the replica, comprises:
computer usable program code for detecting a timeout condition during use of a collaborative client editing the replica; and,
computer usable program code for, responsive to detecting the timeout condition, committing changes in the replica and subsequently destroying the replica.

19. A collaborative document management data processing system comprising:
a host computing platform supporting a document management system managing a plurality of documents;
a lease policy established for the documents;
a plurality of collaborative computing clients coupled to the document management system; and,
lease enforcement logic coupled to each of the collaborative clients, the lease enforcement logic comprising program code enabled to limit use of replicas of corresponding ones of the documents according to the lease policy.

20. The system of claim 19, wherein the lease policy comprises attributes limiting use of a replica to a period of time defined by one of active editing of the replica, active use of a collaborative client editing the replica, and closing of the replica.
